(19) United States
(12) Patent Application Publication
(10) Pub. No.: US 2004/0251669 A1
(43) Pub. Date: Dec. 16, 2004

(54) Method of folding air bag and an associated apparatus

(75) Inventors: Kurt F. Fischer, Oxford, MI (US); Alberto Rodriguez, Rochester Hills, MI (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Vehicle Safety Systems Inc.

(21) Appl. No.: 10/852,869

(22) Filed: May 25, 2004

Related U.S. Application Data
(63) Continuation-in-part of application No. 10/085,214, filed on Feb. 28, 2002, now Pat. No. 6,739,622.
Application No. 10/085,214 is a continuation-in-part of application No. 09/822,132, filed on Mar. 30, 2001, now abandoned.

(51) Int. Cl. B60R 21/16; B60R 21/22

(52) U.S. Cl. 280/743.1

(57) ABSTRACT

A method of disposing an inflatable vehicle occupant protection device (10b) in a stored condition adjacent a retainer (212) to which the protection device (10b) is connected and an associated apparatus are provided. During the method, a bottom portion (252) of the protection device (10b) is packed. Parts of first and second side portions (254 and 256) of the protection device (10b) are disposed in a stack (276) with the bottom portion (252) so that the stack (276) includes three layers (280, 282, and 284). A first side surface (290) of the stack (276) is positioned adjacent the retainer (212). A flap (302) is formed from a top portion (250) of the protection device (10b). The flap (302) is extended from the retainer (212) and over a second side surface (292) of the stack (276).

### RELATED APPLICATIONS

This application is a continuation-in-part of copending U.S. patent application Ser. No. 10/085,214, filed Feb. 28, 2002, which is a continuation-in-part of U.S. patent application Ser. No. 09/822,132, filed Mar. 30, 2001, which is now abandoned.

### TECHNICAL FIELD

The present invention relates to a method of folding the inflatable vehicle occupant protection device, such as an air bag. The present invention also relates to an inflatable vehicle occupant protection apparatus that includes an inflatable vehicle occupant protection device.

### BACKGROUND OF THE INVENTION

U.S. Pat. No. 5,275,435 shows a folded air bag. As the air bag inflates, a first folded portion pivots and moves sideways to contact the vehicle occupant. The first folded portion directs the vehicle occupant off to one side of the inflating air bag, and the remainder of the air bag inflates to the side of the vehicle occupant.

U.S. Pat. No. 6,092,839 shows a method of folding an air bag in which the air bag is first folded in a bottom to top direction and then in a side to side direction.

### SUMMARY OF THE INVENTION

The present invention relates to a method of disposing an inflatable vehicle occupant protection device in a stored condition adjacent a retainer to which the inflatable vehicle occupant protection device is connected. The inflatable vehicle occupant protection device includes a bottom portion, a top portion, and first and second side portions. The method comprises the steps of: packing the bottom portion of the inflatable vehicle occupant protection device; disposing parts of the first and second side portions that are packed with the bottom portion in a stack with the bottom portion so that the stack includes three layers, one of which is formed by the bottom portion and two of which are formed by the first and second side portions; positioning a first side surface of the stack adjacent the retainer; forming a flap from the top portion of the inflatable vehicle occupant protection device; and extending the flap from the retainer and over a second side surface of the stack, the second side surface of the stack being located opposite the first side surface of the stack.

The present invention also relates to an apparatus comprising a retainer and an inflatable vehicle occupant protection device that is connected to the retainer. The inflatable vehicle occupant protection device includes a bottom portion, a top portion, and first and second side portions. The inflatable vehicle occupant protection device has a stored condition in which the bottom portion is packed and parts of the first and second side portions that are packed with the bottom portion are disposed in a stack with the bottom portion. The stack includes three layers. The bottom portion forms one layer of the stack. The first and second side portions form two layers of the stack. The stack includes opposite first and second side surfaces. A first side surface of the stack is positioned adjacent the retainer. In the stored condition, the top portion of the inflatable vehicle occupant protection device forms a flap. The flap extends from the retainer and over the second side surface of the stack.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a schematic side view of a portion of a vehicle including an air bag in accordance with the present invention, shown in phantom in an inflated condition;

FIG. 2 is an enlarged back view of the air bag of FIG. 1 shown in a first configuration laid flat for folding;

FIG. 3 is a schematic sectional view of the air bag of FIG. 2, taken along line 3-3 of FIG. 2;

FIG. 4 is a front view similar to FIG. 2 of the air bag of FIG. 1;

FIG. 5 is a view similar to FIG. 2 showing the air bag in a condition after being folded from the first configuration shown in FIG. 2;

FIG. 6 is a schematic sectional view of the air bag of FIG. 5, taken along line 6-6 of FIG. 5;

FIG. 7 is a view similar to FIG. 5 showing the air bag in a condition after being folded further from the condition shown in FIG. 5;

FIG. 8 is a schematic sectional view of the air bag of FIG. 7, taken along line 8-8 of FIG. 7;

FIGS. 9-14 are a series of views similar to FIG. 8 showing subsequent steps in the folding of the air bag into a second configuration;

FIGS. 15 and 16 are views illustrating subsequent side to side folding of the air bag into a third configuration;

FIG. 17 is a schematic illustration of an air bag shown in a first configuration laid flat for folding;

FIGS. 18-22 are a series of schematic views showing steps in the folding of the air bag of FIG. 17 into a second configuration;

FIGS. 23 and 24 are schematic views illustrating alternative steps in the folding process of FIGS. 21 and 22;

FIGS. 25-31 are schematic illustrations, similar to FIG. 18, of air bags shown in a first configuration laid flat for folding;

FIG. 32 is a schematic illustration of an air bag shown in a first configuration laid flat for folding;

FIGS. 33-40 are a series of schematic views showing steps in the folding of the air bag of FIG. 32 into a second configuration;

FIG. 41 is a schematic view illustrating an alternative step in the folding process of FIG. 38;

FIGS. 42-47 are schematic views showing steps in the folding of the air bag of FIG. 33 into an alternative second configuration;

FIG. 48 is a schematic illustration of an air bag shown in a first configuration laid flat for folding;

FIG. 49 is a schematic view showing the air bag of FIG. 48 in a second configuration; and

FIG. 50 is a schematic view showing an air bag similar to the air bag of FIG. 48 in a second configuration.

### DETAILED DESCRIPTION OF THE INVENTION

The present invention relates to an inflatable vehicle occupant protection device, such as an air bag. As representative of the invention, FIG. 1 illustrates an air bag 10. The air bag 10 forms part of an air bag module 12 mounted in the instrument panel 14 of a vehicle 16.

The air bag module 12 also includes an inflator (not shown) that contains an inflation fluid source for inflating the air bag 10. The inflation fluid source may be a stored quantity of pressurized inflation fluid and an ignitable material for heating the inflation fluid. The inflation fluid source alternatively could use the combustion of gas-generating material to generate inflation fluid in the form of gas to inflate the air bag 10, or could be a stored quantity of pressurized inflation fluid for inflating the air bag.

The vehicle 16 includes a front passenger seat 18 for an occupant of the vehicle. The vehicle windshield 20 extends upward and rearward from the instrument panel 14, and merges with the vehicle roof 22. In the vehicle 16, a forward direction is illustrated by the arrow 24, and a rearward direction by the arrow 26. An upward direction in the vehicle 16 is illustrated by the arrow 28, and a downward direction in the vehicle is illustrated by the arrow 30.

The air bag module 12 is mounted in an upward facing location in the instrument panel 14, and is thus a “top-mount” type of module. The air bag module 12 includes a container 40 secured in the instrument panel 14 in a manner not shown. The container 40 includes a main body portion 42 and a door 44. The door 44 is hinged to the main body portion 42 of the container 40 at the top of the container. It should be understood that the container 40 may have a different configuration from the one shown, or may be a portion of the instrument panel 14 itself.

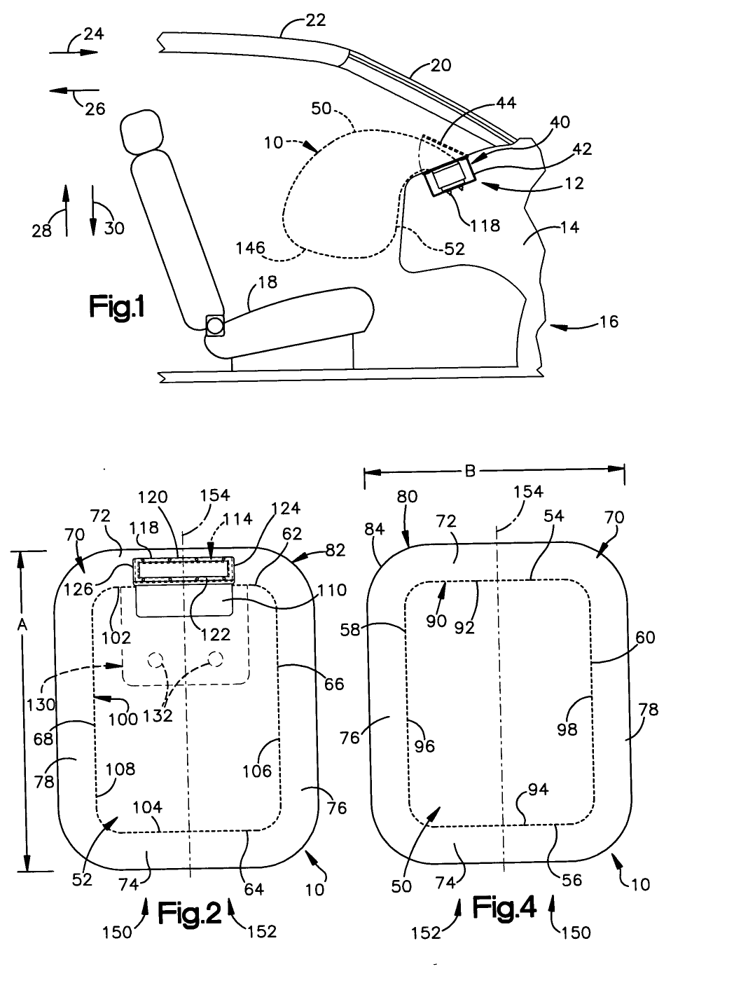

The air bag 10 (FIGS. 2-4) includes a contact face or front panel 50 (FIG. 4) that is closest to the vehicle occupant when the air bag is inflated, and a back panel 52 that is farthest from the vehicle occupant when the air bag is inflated. The front panel 50 and the back panel 52, as shown, are similar or identical in size and shape to each other.

The front panel 50 (FIG. 4) is, preferably, a single piece of material. The front panel 50 may, alternatively, be constructed of a plurality of pieces of fabric material that are sewn together to form the front panel. The front panel has a generally rectangular configuration, with rounded corners. The front panel 50 has a top edge 54, a bottom edge 56, and inboard and outboard side edges 58 and 60.

The back panel 52 is, preferably, a single piece of material. The back panel 52 may, alternatively, be constructed of a plurality of pieces of fabric material that are sewn together to form the back panel. The back panel 52 has a generally rectangular configuration, with rounded corners. The back panel 52 has a top edge 62, a bottom edge 64, and inboard and outboard side edges 66 and 68.

The air bag further includes a side panel 70, which connects the front panel 50 and the back panel 52. The side panel 70 is preferably made from a plurality of pieces of fabric materials that are sewn together to form the side panel. The side panel 70 extends between the front panel 50 and the back panel 52 when the air bag 10 is inflated. Because of the presence of the side panel 70, the front and back panels 50 and 52 move apart from each other and the air bag 10 has a substantial depth when inflated.

The side panel 70 has the general configuration of an open rectangle when the air bag 10 is viewed as in FIGS. 2 and 4, extending completely around the front panel 50 and the back panel 52. This rectangular configuration includes a top side portion 72, a bottom side portion 74, an inboard side portion 76 and an outboard side portion 78.

The side panel 70 has parts on both the front and the back of the air bag 10 when the air bag is laid flat as seen in FIGS. 2 and 4. Specifically, the side panel 70 has a front part 80 that is located on the front of the air bag 10, and a back part 82 that is located on the back of the air bag. The side panel 70 is folded at a fold line 84 between the front and back parts 80 and 82 when the air bag 10 is laid flat as shown in FIGS. 2 and 4. The fold line 84 forms the outer edge of the air bag 10 when the air bag is in the configuration shown in FIGS. 2-4.

The side panel 70 is sewn to the front panel 50 (FIG. 4) with a front seam 90. The front seam 90 extends completely around the front panel 50. The front seam 90 includes a top seam portion 92 that joins the top edge 54 of the front panel 50 to the top side portion 72 of the side panel 70. The front seam 90 includes a bottom seam portion 94 that joins the bottom edge 56 of the front panel 50 to the bottom side portion 74 of the side panel 70. An inboard seam portion 96 joins the inboard edge 58 of the front panel 50 to the inboard side portion 76 of the side panel 70. An outboard seam portion 98 joins the outboard edge 60 of the front panel 50 to the outboard side portion 78 of the side panel 70.

The side panel 70 is sewn to the back panel 52 (FIG. 2) with a back seam 100. The back seam 100 extends completely around the back panel 52. The back seam 100 includes a top seam portion 102 that joins the top edge 62 of the back panel 52 to the top side portion 72 of the side panel 70. The back seam 100 includes a bottom seam portion 104 that joins the bottom edge 64 of the back panel 52 to the bottom side portion 74 of the side panel 70. An inboard seam portion 106 joins the inboard edge 66 of the back panel 52 to the inboard side portion 76 of the side panel 70. An outboard seam portion 108 joins the outboard edge 68 of the back panel 52 to the outboard side portion 78 of the side panel 70.

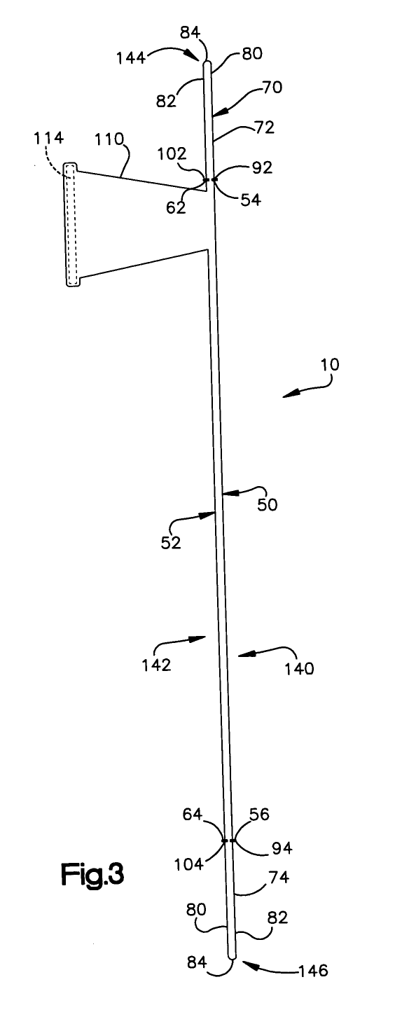

The air bag 10 includes a throat 110 (FIG. 3) for directing inflation fluid into the air bag. The throat 110 is sewn to and extends outward from the back panel 52. A retaining ring, or retainer 114, is connected with the end of the throat 110 opposite the back panel 52. The retainer 114 is a rigid member, preferably made from metal, that has fastening means 116 for securing the air bag 10 to the vehicle instrument panel. In the illustrated embodiment, the fastening means 116 includes eight threaded studs that project from a main body portion 118 of the retainer 114. The main body portion 118 of the retainer 114 has a generally rectangular configuration including top and bottom portions 120 and 122 and inboard and outboard side portions 124 and 126.

The air bag 10 includes an inner bag 130, shown only in FIGS. 2, 5 and 7. The inner bag 130 is in fluid communication with the throat 110. The inner bag 130 has one or more vents 132 for directing fluid from the inner bag 130 into the other parts of the air bag 10, in a known manner.

In the process of manipulating the material of the air bag 10 into a condition in which the air bag is storable in the instrument panel 14 (FIG. 1), the air bag is placed in a first configuration as seen in FIGS. 2-4. In the first configuration, the air bag 10 is laid substantially flat. The front panel 50 of the air bag is underneath the back panel 52. The side panel 70 extends outwardly from the front and back panels 50 and 52.

When the air bag 10 is in this first configuration, the air bag has a front part 140 and a back part 142 that overlie each other. The front part 140 comprises the front panel 50 and the front part 80 of the side panel 70. The back part 142 comprises the back panel 52 and the back part 82 of the side panel 70.

The air bag 10 when in the first configuration has a top edge 144, which comprises the fold line 84 in the top side portion 72 of the side panel 70. The retainer 14 is adjacent the top edge 144 of the configuration. The air bag 10 when in the first configuration has a bottom edge 146, which comprises the fold line 84 in the bottom side portion 74 of the side panel 70.

The air bag 10 when in the first configuration has a first portion 150 that is located on the outboard side (to the left as viewed in FIG. 2 and to the right as viewed in FIG. 4) of a top to bottom centerline 154 of the air bag 10. The air bag when in the first configuration has a second portion 152 that is located on the inboard side (to the right as viewed in FIG. 2 and to the left as viewed in FIG. 4) of the top to bottom centerline 154.

The air bag 10 has a height “A” (FIG. 2) measured in a direction along the top to bottom centerline 154 of the air bag. The air bag 10 has a width “B” (FIG. 4) measured in a direction perpendicular to the centerline 154. The height “A” of the air bag 10 is substantially greater than the width “B” of the air bag, in the illustrated embodiment.

The retainer 114 has a height “C” (FIG. 7) measured in a direction along the top to bottom centerline 154 of the air bag. The retainer 114 has a width “D” (FIG. 7) measured in a direction perpendicular to the centerline 154. The height “C” of the retainer 114 is substantially less than the width “D” of the retainer, in the illustrated embodiment.

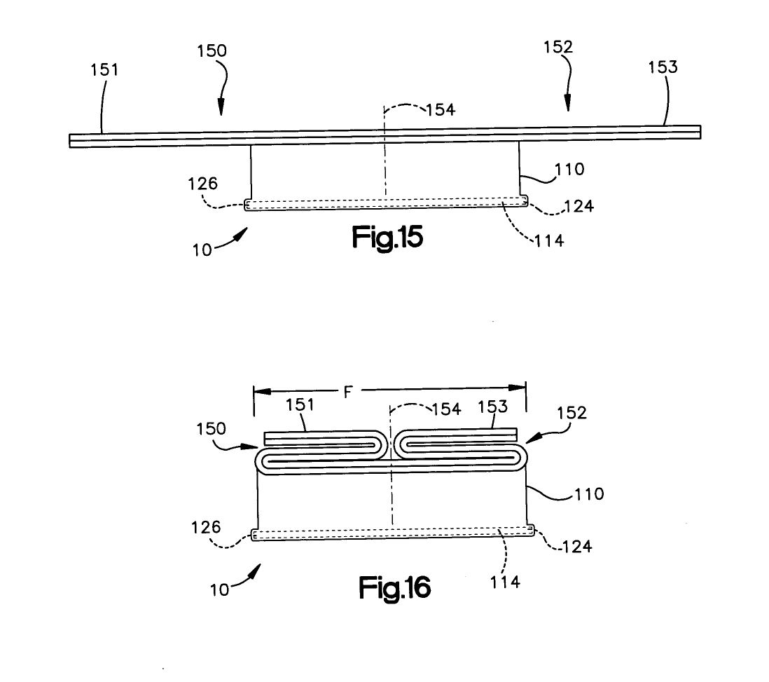

After the air bag 10 is placed in the first configuration shown in FIGS. 2-4, the air bag is manipulated, in a series of folding and rolling steps, from the first configuration to a second configuration as shown in FIG. 14. These steps include rolling the air bag 10 up from bottom to top, in a manner described below in detail with reference to FIGS. 5-14. After the air bag 10 is manipulated into the second configuration shown in FIG. 14, the air bag is manipulated, in a series of folding steps, from the second configuration to a third configuration shown in FIG. 16. These steps include folding the air bag 10 side to side, in a manner described below in detail with reference to FIGS. 15 and 16.

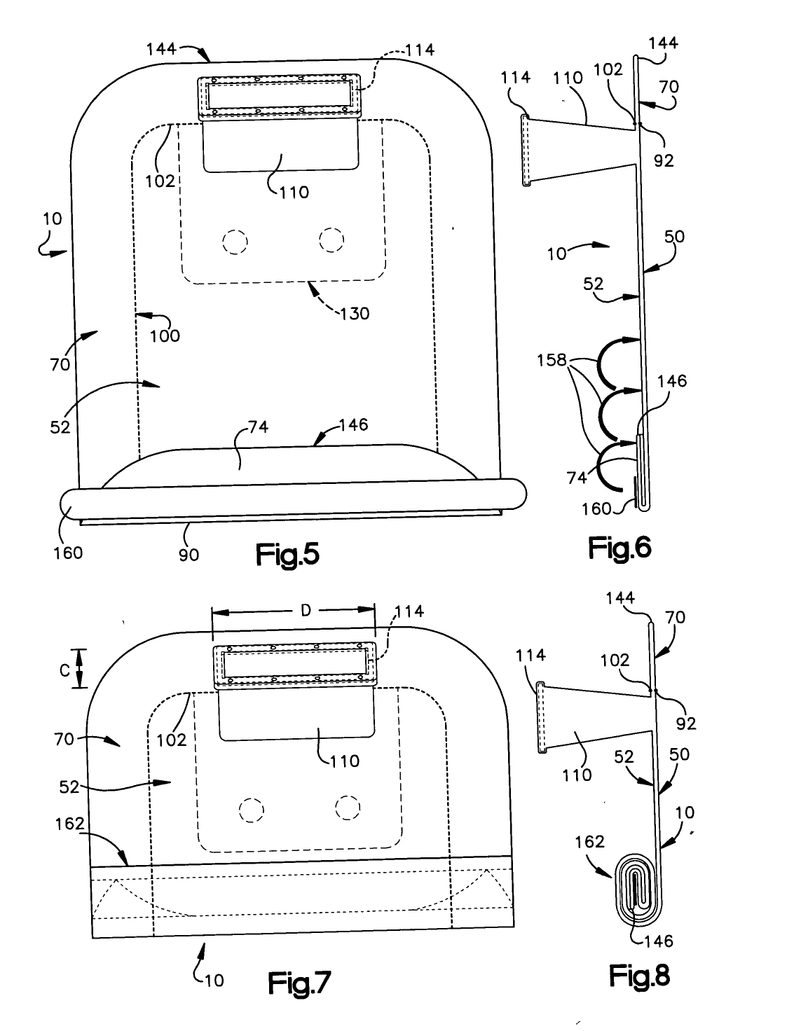

To start the bottom to top rolling process, the air bag 10 (FIGS. 5 and 6) is “flat rolled” along the bottom portions 94 and 104 of the front and back seams 90 and 100, respectively. This moves the bottom side portion 74 of the side panel 70 into a position overlying the back panel 52, as shown in FIGS. 5 and 6.

Next, the air bag 10 is flat rolled three to four times in a bottom to top direction, as shown by the arrows 158 in FIGS. 6-8. This rolling may be performed with the aid of a paddle 160 to help provide rolled sections that are all of the same, specific height. The rolled sections that result have a smaller height than the first rolled section shown in FIGS. 5 and 6. The air bag 10 is rolled up in this manner only until the bottom edge of the inner bag 130 is reached. The roll 162 that results may be clamped with clamps (not shown), and the paddle 160 removed.

Then, the top side portion 72 of the side panel 70 is grasped and repositioned, moving the air bag 10 from the condition shown in FIG. 8 to the condition shown in FIG. 9. As a result, the top seam portion 92 of the front seam 90, which joins the top edge 54 of the front panel 50 to the top side portion 72 of the side panel 70, is adjacent the roll 162. The top seam portion 102 of the back seam 100, which joins the top edge 62 of the back panel 52 to the top side portion 72 of the side panel 70, is located adjacent the throat 110. The side panel 70 and the front panel 50 overlie one another.

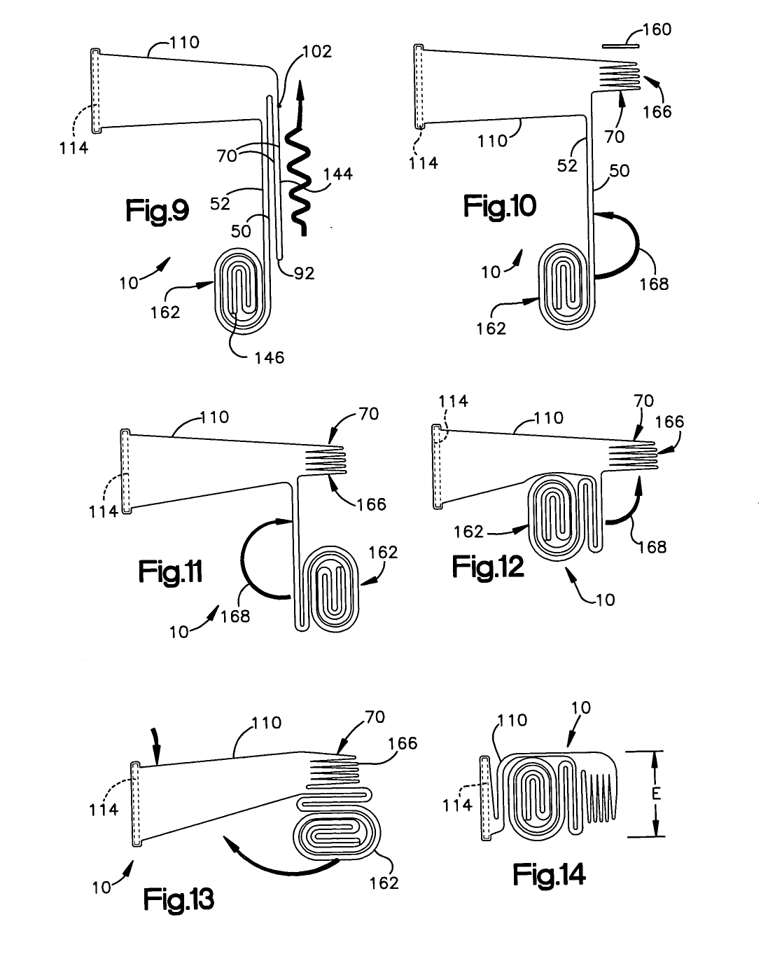

The paddle 160 is then positioned relative to the air bag 10 as shown in FIG. 10, standing upright along its long edge. The top side portion 72 of the side panel 70 is accordion folded in a manner shown in FIGS. 9 and 10. Four to five accordion folds are made, and are placed adjacent the paddle 160. The paddle 160 helps to set the height of the folds and insure uniformity of the folds. The resulting stack 166 of folded portions of the top side portion 72 of the side panel 70 may be held together with one or more clamps (not shown). It should be understood that the illustration of the stack 166 in FIG. 10 is only schematic, and that a larger or smaller number of folded portions may be provided.

The roll 162 is then “flip folded” three to four times, as shown by the arrows 168 so that it lies first against the front panel 50 and then against the back panel 52, until it is adjacent the stack of folds 166, as shown in FIGS. 10-12. The air bag 10 is then rotated 90 degrees and tucked against the throat 110, as shown in FIGS. 13 and 14, so that the air bag has a height “E” (as measured in a direction along the centerline 154) corresponding to the height “C” of the retainer 114.

The air bag 10 is then folded inward from the fold lines 84 in the inboard and outboard side portions 76 and 78 toward the centerline 154 (FIGS. 15 and 16). The inward folding gives the air bag a width “F” (as measured in a direction perpendicular to the centerline 154) corresponding to the width “D” of the retainer 114. When the air bag 10 is in the condition shown in FIG. 15, it has portions 151 and 153 that project laterally beyond the sides 126 and 124, respectively, of the retainer 114. The portions 151 and 153 include the inboard and outboard side portions 78 and 76, respectively.

The first portion 150 of the air bag 10 (to the left of the centerline 154 as viewed in FIGS. 15 and 16) is then folded laterally inward in a Z-fold configuration so that the projecting portion 151 does not extend past the side 126 of the retainer 114. Then, the second portion 152 of the air bag 10 (to the right of the centerline 154 as viewed in FIGS. 15 and 16) is folded laterally inward in a Z-fold configuration so that the projecting portion 153 does not extend past the side 124 of the retainer 114. The second portion 152 of the air bag 10 is folded as a mirror image of the first portion 150. As viewed in FIG. 16, the first and second projecting portions 151 and 153 are folded to form a stack of folds adjacent the retainer 114 with the side part of the air bag 10 being on top of the stack. The stack has a width corresponding to the final folded condition of the air bag 10. The folded air bag 10 is then in a condition to be mounted in the vehicle 16.

When the air bag 10 is inflated, substantially all portions of the air bag begin to inflate. The Z-folds of the first and second portions 150 and 152 of the air bag, which are folded side to side in the final folding steps of the process, are the first to inflate fully. As the first and second portions 150 and 152 inflate, the laterally folded portions 153 and 151, including the inboard and outboard side portions 76 and 78, move laterally outward, away from the retainer 114. This lateral movement occurs prior to any substantial unrolling or unfolding of the air bag 10 in the top to bottom direction (along the centerline 154). Because the first and second portions 150 and 152 of the air bag 10 are folded as mirror images of each other, the inboard and outboard side portions 76 and 78 inflate and unfold equally rapidly. This promotes rapid inflation of the portions 150 and 152, and can help to protect an occupant who is located to one side or the other of the inflating air bag 10.

As a result, if the occupant of the seat 18 is relatively close to the instrument panel 14 when the air bag 10 begins to inflate, the occupant is first contacted by laterally moving portions of the air bag 10. The air bag portions moving laterally tend to push the occupant at least partially laterally, rather than completely rearward, in the vehicle 16. This can help to minimize force transmitted to the vehicle occupant by the inflating air bag 10.

Eventually, as the air bag 10 inflates more completely, the roll 162 unrolls and inflates outward and downward, away from the windshield 20. Because of the direction in which the material of the roll 162 is rolled, it unrolls away from the occupant of the seat 18. Specifically, the rolled layers of the air bag 10 are rolled up during the folding process along the back panel 52 of the air bag, opposite the front panel or contact face 50 of the air bag. During inflation of the air bag 10, the front panel 50 of the air bag 10 is presented toward the occupant. The front panel 50 of the air bag 10 contacts the head and face of the occupant, and the back panel 52 of the air bag does not.

Therefore, inflation of the air bag 10 causes the roll 162 to unroll from a side of the air bag 10 opposite the occupant of the seat 18. The roll 162 unrolls in a clockwise direction (as viewed in FIG. 1) and in a direction away from the occupant of the seat 18, that is, in the forward direction 24 in the vehicle 16. As a result, a relatively flat portion of the front panel 50 moves into contact with the head of the occupant, and remains there as the roll 162 continues to unroll.

FIGS. 17-22 illustrate schematically a process of folding an air bag in accordance with a second embodiment of the invention. The folding process shown in FIGS. 17-22 is similar to the folding process shown in FIGS. 1-16. The folding process shown in FIGS. 17-22, like the folding process shown in FIGS. 1-16, is applicable to air bags of configurations different from that shown in the drawings.

The air bag 10a shown in FIGS. 17-22 is shown schematically only, and may be similar to the air bag 10 (FIGS. 1-16), but is not necessarily identical. For example, the air bag 10a as illustrated does not have a throat, or chute, between the retainer and the body portion of the air bag.

The air bag 10a includes a retainer 170 that is similar to, and may be the same as, the retainer 114 (FIGS. 1-16). The retainer 170 has top and bottom edges 172 and 174. The retainer 170 has a front face 176 that is closest to the vehicle occupant when the air bag 10a is inflated, and a back face 178 that is farthest from the vehicle occupant when the air bag is inflated. During inflation of the air bag 10a, inflation fluid flows through the retainer 170 in a direction from the back face 178 to the front face 176.

In the process of manipulating the material of the air bag 10a into a condition in which the air bag is storable in the instrument panel 14 (FIG. 1), the air bag is placed in a first configuration as seen in FIGS. 17 and 18. In the first configuration, the air bag 10a is laid substantially flat. When the air bag 10a is in this first configuration, the air bag has a front part 180 and a back part 182 that overlie each other.

The air bag 10 when in the first configuration has a top edge 184, which comprises a fold line 186. The air bag 10a when in the first configuration has a bottom edge 188, which comprises a fold line 190. The retainer 170 is located about in the middle (top to bottom) of the configuration of the air bag 10a. A top portion 192 of the air bag 10a extends upward from the retainer 170, and a bottom portion 194 extends downward from the retainer.

The air bag 10a when in the first configuration has a first portion 196 (FIG. 17) that is located on the outboard side (to the left as viewed in FIG. 17) of a top to bottom centerline 198 of the air bag. The air bag 10a when in the first configuration has a second portion 200 that is located on the inboard side (to the right as viewed in FIG. 17) of the top to bottom centerline 198. Most of the material of the first and second portions 196 and 200 is located laterally outward of the retainer 170.

The air bag 10a has a height “A′” (FIG. 17) measured in a direction along the top to bottom centerline 198 of the air bag. The air bag 10a has a width “B′” (FIG. 17) measured in a direction perpendicular to the centerline 198. The height “A′” of the air bag 10a is substantially greater than the width “B′” of the air bag, in the illustrated embodiment.

The retainer 170 has a height “C′” (FIG. 17) measured in a direction along the top to bottom centerline 198 of the air bag 10a. The retainer 170 has a width “D′” (FIG. 17) measured in a direction perpendicular to the centerline 198. The height “C′” of the retainer 170 is substantially less than the width “D′” of the retainer, in the illustrated embodiment.

After the air bag 10a is placed in the first configuration shown in FIGS. 17 and 18, the air bag is manipulated, in a series of folding and/or rolling steps, from the first configuration to a second configuration as shown in FIG. 22.

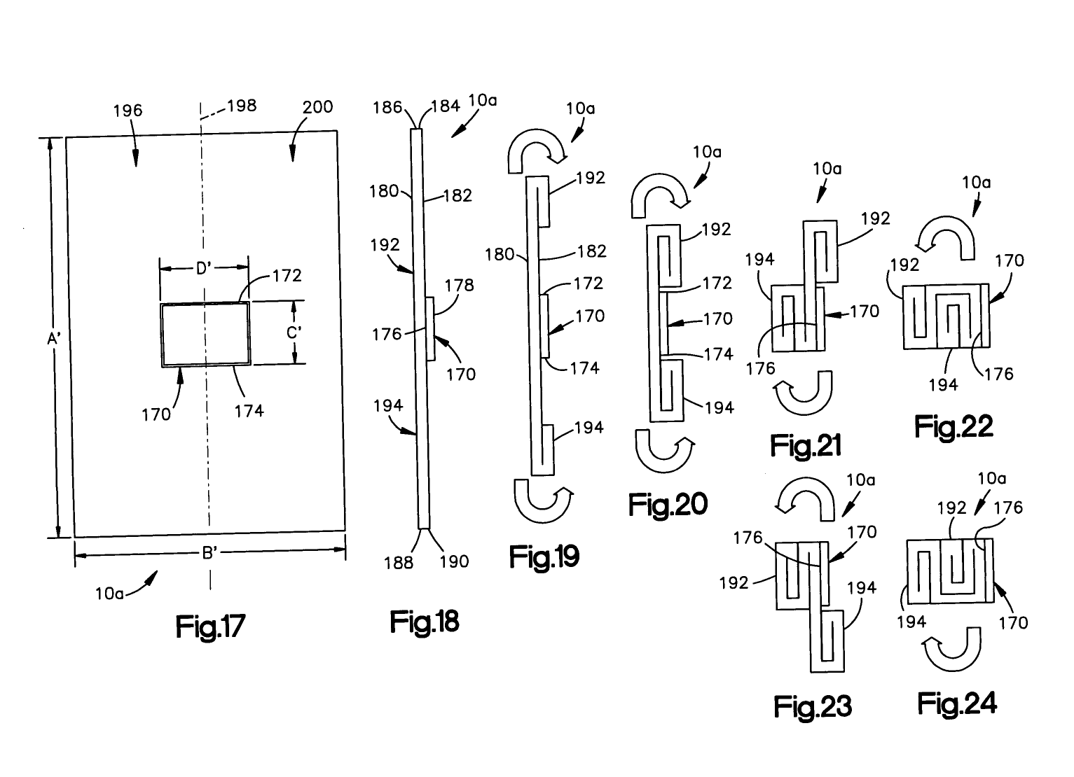

To start this process, the top portion 192 of the air bag 10 is “flat rolled” downward onto the back part 182, into a position adjacent the top edge 172 of the retainer 170, as shown schematically in FIGS. 19 and 20. Similarly, the bottom portion 194 of the air bag 10a is “flat rolled” upward onto the back part 182, into a position adjacent the bottom edge 174 of the retainer 170, as shown in FIGS. 19 and 20. While these steps are occurring, the first and second portions 196 and 200 of the air bag 10a remain laterally outward of the retainer 170. It should be understood that the top and bottom portions 192 and 194 could be moved into their respective positions adjacent the retainer 170 by folding or rolling steps that are different from those shown in FIGS. 19 and 20.

Next, the bottom portion 194 (FIG. 21) of the air bag 10a is flip folded so that it lies adjacent the front face 176 of the retainer 170. Then, the top portion 192 (FIG. 22) of the air bag 10a is flip folded so that it overlies the bottom portion 194 of the air bag, thus overlying also the front face 176 of the retainer 170. The top portion 192 of the air bag 10 is outermost in the stack of folded air bag portions.

The folded air bag 10a has a height (as measured in a direction along the centerline 198) corresponding to the height “C′” of the retainer 170. At this point in the folding process, the first and second portions 196 and 200 of the air bag 10a are still located laterally outward of the retainer 170.

The first and second portions 196 and 200 of the air bag 10a are then folded laterally inward toward the centerline 198, in a manner as shown in FIGS. 15 and 16 with respect to the air bag 10. This folding step gives the air bag a width (not shown) as measured in a direction perpendicular to the centerline 198 corresponding to the width “D′” of the retainer 170. The second portion 200 of the air bag 10a is folded as a mirror image of the first portion 196. The folded air bag 10a is then in a condition to be mounted in the vehicle 16.

When the air bag 10a is inflated, it inflates in a manner substantially similar to that of the air bag 10 (FIGS. 1-16). The first and second portions 196 and 200 inflate and move laterally outward, away from the retainer 170. This lateral movement occurs prior to any substantial unrolling or unfolding of the air bag 10a in the top to bottom direction (along the centerline 198). Because the first and second portions 196 and 200 of the air bag 10a are folded as mirror images of each other, the first and second portions inflate and unfold equally rapidly. This promotes rapid inflation of the portions 196 and 200, and can help to protect an occupant who is located to one side or the other of the inflating air bag 10.

Eventually, as the air bag 10a inflates more completely, the top portion 192 of the air bag inflates upward, because it has been folded or rolled downward to the retainer 170. The bottom portion 194 of the air bag 10a inflates downward, because it has been folded or rolled upward to the retainer 170.

FIGS. 23 and 24 illustrate schematically two folding steps that can be substituted for the folding steps shown in FIGS. 21 and 22. In the folding steps shown in FIGS. 23 and 24, the top portion 192 of the air bag 10a is folded first onto the front face 176 of the retainer 170, and the bottom portion 194 of the air bag is thereafter folded onto the top portion 192. This folding procedure can help to promote inflation of the bottom portion 194 of the air bag 10a prior to inflation of the top portion 192 of the air bag.

FIGS. 25-31 illustrate schematically several alternative methods, in accordance with the present invention, of folding the air bag 10a. The methods differ from each other with respect to where (in a top to bottom direction) the retainer is located at the beginning of the folding process, and also with respect to the direction of folding of one or more portions of the air bag. In each one of FIGS. 25-31, the air bag is shown in a first configuration like the first configuration shown in FIG. 18.

In FIG. 25, the air bag 10a is shown with its retainer 170 in the middle, as in FIGS. 17 and 18. As indicated by the arrow 210, the top portion 192 of the air bag 10a can be folded in a direction toward the front face 176 of the retainer 170. Alternatively, and as indicated by the arrow 212, the top portion 192 of the air bag 10a can be folded in the opposite direction, toward the back face 178 of the retainer 170, in the manner described above with reference to FIGS. 19 and 20. In either case, the top portion 192 of the air bag is folded to a position adjacent the top edge 172 of the retainer 170, for example, as shown in FIG. 20.

Similarly, as indicated by the arrow 214, the bottom portion 194 of the air bag 10a can be folded in a direction toward the front face 176 of the retainer 170. Alternatively, and as indicated by the arrow 216, the bottom portion 194 of the air bag 10a can be folded in the opposite direction, toward the back face 178 of the retainer 170, in the manner described above with reference to FIGS. 19 and 20. In either case, the bottom portion 194 of the air bag 10a is folded to a position adjacent the bottom edge 174 of the retainer 170, for example, as shown in FIG. 20.

To finish the top-to-bottom folding of the air bag 10a, the bottom portion 194 of the air bag 10a can be moved first into a position overlying the retainer 170, followed by the top portion 192, in the manner shown in FIGS. 21 and 22. Alternatively, the top portion 192 of the air bag 10a can be moved first into a position overlying the retainer 170, followed by the bottom portion 194, in the manner shown in FIGS. 23 and 24.

In FIG. 26, the air bag 10a is shown in a first configuration with its retainer 170 at the top, like the air bag 10 shown in FIGS. 1-16. Because the retainer 170 is at the top of the configuration, substantially all of the air bag 10a is a bottom portion 194 that is folded upward to the retainer. As indicated by the arrow 218, the bottom portion 194 of the air bag 10a can be folded in a direction toward the front face 176 of the retainer 170. Alternatively, and as indicated by the arrow 220, the bottom portion 194 of the air bag 10a can be folded in the opposite direction, toward the back face 178 of the retainer 170. In either case, the bottom portion 194 of the air bag 10a is folded to a position adjacent the bottom edge 174 of the retainer 170, as shown, for example, in FIG. 20.

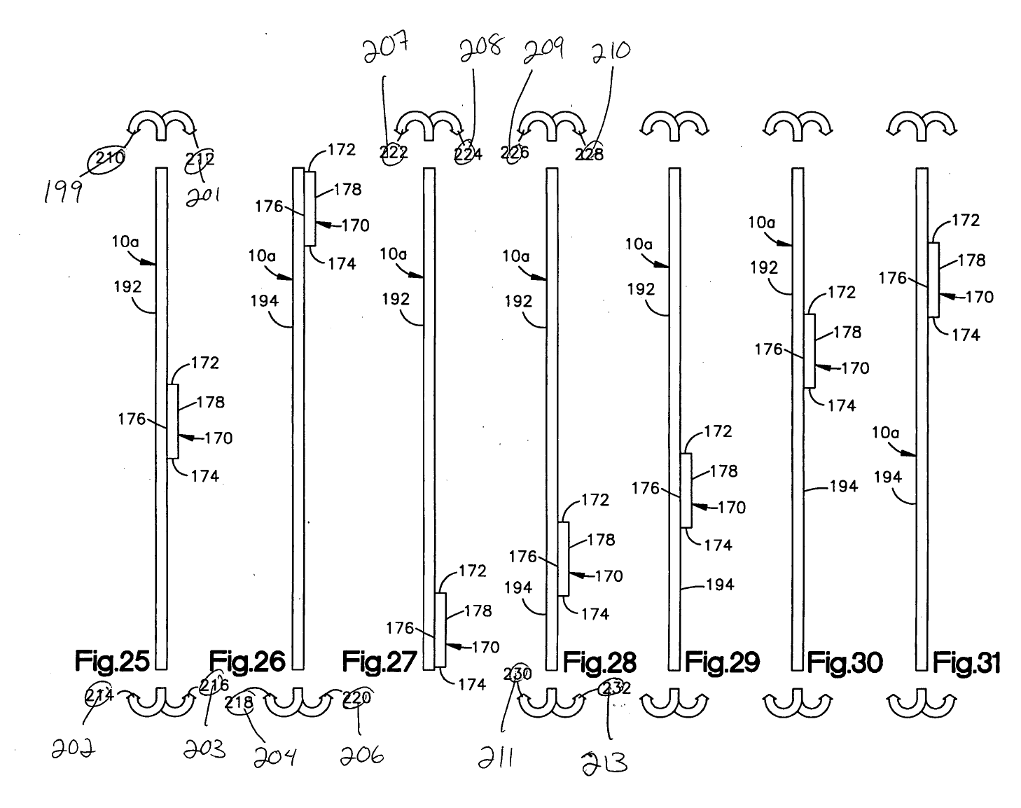

In FIG. 27, the air bag 10a is shown in a first configuration with its retainer 170 at the bottom, the opposite of the configuration shown in FIG. 26. Because the retainer 170 is at the bottom of the configuration, substantially all of the air bag 10a is a top portion 192 that is folded downward to the retainer. As indicated by the arrow 222, the top portion 192 of the air bag 10a can be folded in a direction toward the front face 176 of the retainer 170. Alternatively, and as indicated by the arrow 224, the top portion 192 of the air bag 10a can be folded in the opposite direction, toward the back face 178 of the retainer 170. In either case, the top portion 192 of the air bag 10a is folded to a position adjacent the top edge 172 of the retainer 170, for example, as shown in FIG. 20.

In FIG. 28, the air bag 10a is shown in a first configuration with its retainer near but not at the bottom of the air bag. Because the retainer 170 is near the bottom of the configuration, most of the air bag 10a is a top portion 192 that is folded downward to the retainer. As indicated by the arrow 226, this top portion 192 can be folded in a direction toward the front face 176 of the retainer 170. Alternatively, and as indicated by the arrow 228, the top portion 192 of the air bag 10a can be folded in the opposite direction, toward the back face 178 of the retainer 170. In either case, the top portion 192 of the air bag 10a is folded to a position adjacent to the top edge 172 of the retainer 170.

In FIG. 28, a smaller part of the air bag 10a is a bottom portion 194 that is folded upward toward the retainer 170. As indicated by the arrow 230, this bottom portion 194 can be folded in a direction toward the front face 176 of the retainer 170. Alternatively, and as indicated by the arrow 232, the bottom portion 194 of the air bag 10a can be folded in the opposite direction, toward the back face 178 of the retainer 170. In either case, the bottom portion 194 is folded to a position adjacent the bottom edge 174 of the retainer 170.

To finish the top-to-bottom folding of the air bag 10a in FIG. 28, the bottom portion 194 of the air bag can be folded into a position overlying the retainer 170, followed by the top portion 192, in the manner shown in FIGS. 21 and 22. Alternatively, the top portion 192 of the air bag 10a can be folded into a first position overlying the retainer 170, followed by the bottom portion 194, in the manner shown in FIGS. 23 and 24.

In FIG. 29, the air bag 10a is shown in a first configuration with its retainer 170 near but below the middle of the air bag. The folding options that are available in this case are similar to those shown in FIG. 28.

In FIG. 30, the air bag 10a is shown in a first configuration with its retainer 170 above but not at the middle of the air bag. The folding options that are available in this case are like those shown in FIG. 29, with top and bottom reversed.

Similarly, in FIG. 31 the air bag 10a is shown in a first configuration with its retainer 170 near but below the top of the air bag. The folding options that are available in this case are like those shown in FIG. 28, with top and bottom reversed.

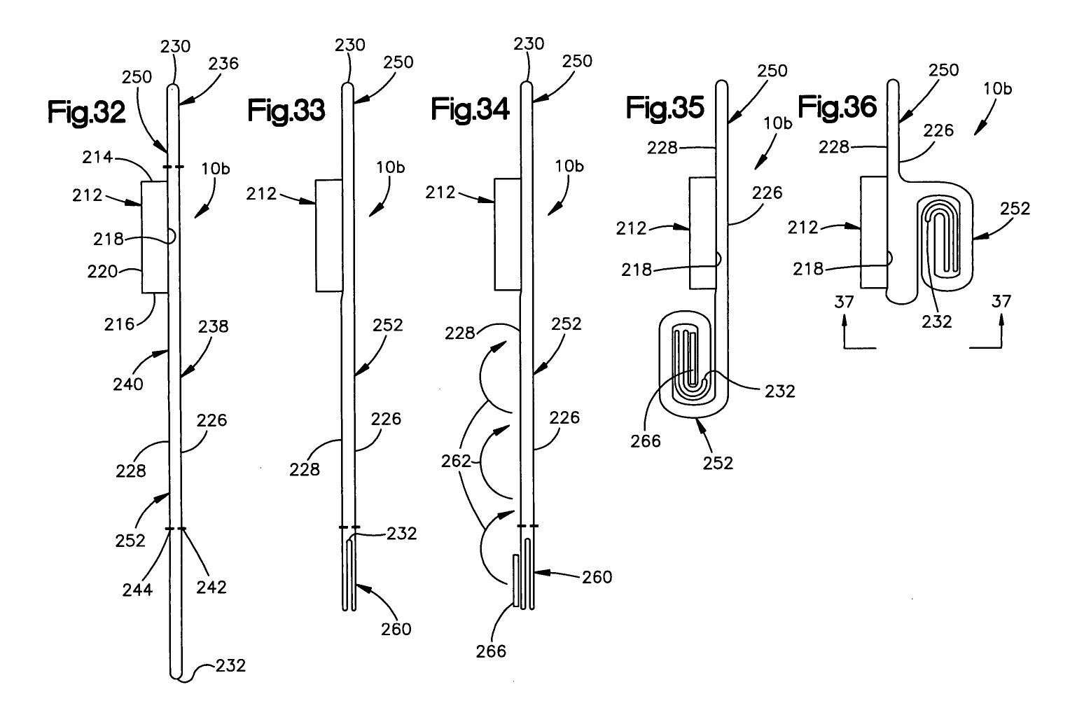

FIGS. 32-40 illustrate schematically a process of folding an air bag 10b in accordance with a third embodiment of the invention. The folding process shown in FIGS. 32-40 is similar to the folding processes shown in FIGS. 1-16 and 17-31. The folding process shown in FIGS. 32-40, like the folding processes shown in FIGS. 1-16 and 17-31, is applicable to air bags of configurations different from that shown in the drawings.

The air bag 10b shown in FIGS. 32-40 may be similar to the air bag 10 of FIGS. 1-16. The air bag 10b includes a retainer 212 that is similar to the retainer 114 of FIGS. 1-16. As shown in FIG. 32, the retainer 212 has top and bottom edges 214 and 216, respectively, and front and back faces 218 and 220, respectively. During inflation of the air bag 10b, inflation fluid flows through the retainer 212 in a direction from the back face 218 to the front face 220. The retainer 212 may have configurations other than that illustrated in FIGS. 32-40. For example, the structure of the retainer 212 illustrated in FIGS. 32-40 may be one wall of a multi-walled retainer.

In the process of manipulating the material of the air bag 10b into a condition in which the air bag is storable in the instrument panel 14 (FIG. 1), the air bag 10b is placed in a first configuration as shown in FIG. 32. In the first configuration, the air bag 10b is laid substantially flat. When the air bag 10b is in this first configuration, the air bag has a front part 226 and a back part 228 with the front part overlying the back part. The air bag 10b when in the first configuration also has top and bottom edges 230 and 232, respectively. The top and bottom edges 230 and 232 comprise fold lines that are located in a side panel 236 of the air bag 10b. The side panel 236 of the air bag 10b connects front and back panels 238 and 240, respectively, of the air bag. A front seam 242 connects the side panel 236 and the front panel. A back seam 244 connects the side panel 236 and the back panel 240.

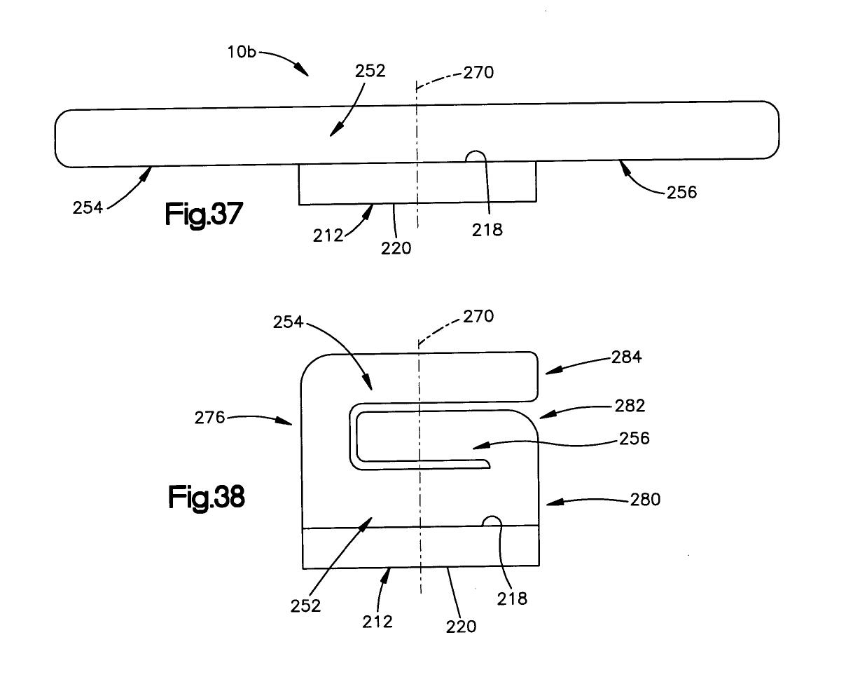

The back panel 240 of the air bag 10b is attached to the retainer 212. The retainer 212 is located nearer the top edge 230 of the air bag 10b than the bottom edge 232. For example, the top edge 214 of the retainer 212 may be approximately 130 millimeters away from the top edge 230 of the air bag 10b and the bottom edge 216 of the retainer may be approximately 740 millimeters away from the bottom edge 232 of the air bag. The air bag 10b, when in the first configuration, as shown in FIG. 32, has a top portion 250 and a bottom portion 252. The top portion 250 of the air bag 10b extends between the retainer 212 and the top edge 230 of the air bag. The bottom portion 252 of the air bag 10b extends between the retainer 212 and the bottom edge 232 of the air bag. The air bag 10b, when in the first configuration, also has first and second side portions that are located on laterally opposites sides of the retainer 212. FIG. 37 illustrates the first and second side portions 254 and 256, respectively, of the air bag 10b.

After the air bag 10b is placed in the first configuration, shown in FIG. 32, the air bag 10b is manipulated, in a series of steps, from the first configuration to a second configuration. FIG. 40 illustrates the air bag 10b in the second configuration. When the air bag 10b is in the second configuration, the air bag 10b is in a stored condition, i.e., in a condition in which the air bag is storable in the instrument panel 14 (FIG. 1).

To start the process of manipulating the air bag 10b from the first configuration to the second configuration, the bottom edge 232 of the air bag 10b is tucked into the air bag to form a pleat 260, as shown in FIG. 33. In a preferred embodiment of the invention, the pleat 260 has a length of approximately 250 millimeters. After the pleat 260 is formed, the bottom portion 252 of the air bag 10b is flat rolled three to four times in a bottom to top direction along the back part 228 of the air bag, as shown by the arrows 262 in FIG. 34. This rolling of the bottom portion 252 of the air bag 10b may be performed with the aid of a paddle 266, as is shown in FIG. 34.

The bottom portion of the air bag 10b is rolled into the configuration shown in FIG. 36. FIG. 35 illustrates the bottom portion 252 in an intermediate configuration prior to reaching the configuration shown in FIG. 36. As shown in FIG. 36, the rolled bottom portion 252 of the air bag 10b is located adjacent to the front face 218 of the retainer 212. After the rolled bottom portion 252 is in the configuration illustrated in FIG. 36, the paddle 266, if used, should be removed.

At this point in the process, the first and second side portions 254 and 256 of the air bag 10b are still located laterally outward of the retainer 212, as shown in FIG. 37. The first and second side portions 254 and 256 of the air bag 10b are then folded laterally inwardly into the positions shown in FIG. 38. In the position shown in FIG. 38, the second side portion 256 of the air bag 10b is folded laterally inwardly over a centerline 270 of the air bag. When folded laterally inwardly, the part of second side portion 256 of the air bag 10b, which was rolled with the bottom portion 252 of the air bag, lies above the bottom portion, as viewed in FIG. 38. The first side portion 254 of the air bag 10b is then folded laterally over the centerline 270 so as to extend over the laterally folded second side portion 256. When folded laterally inwardly, the part of first side portion 254 of the air bag 10b, which was rolled with the bottom portion 252 of the air bag, lies above the second side portion 256 of the air bag, as viewed in FIG. 38.

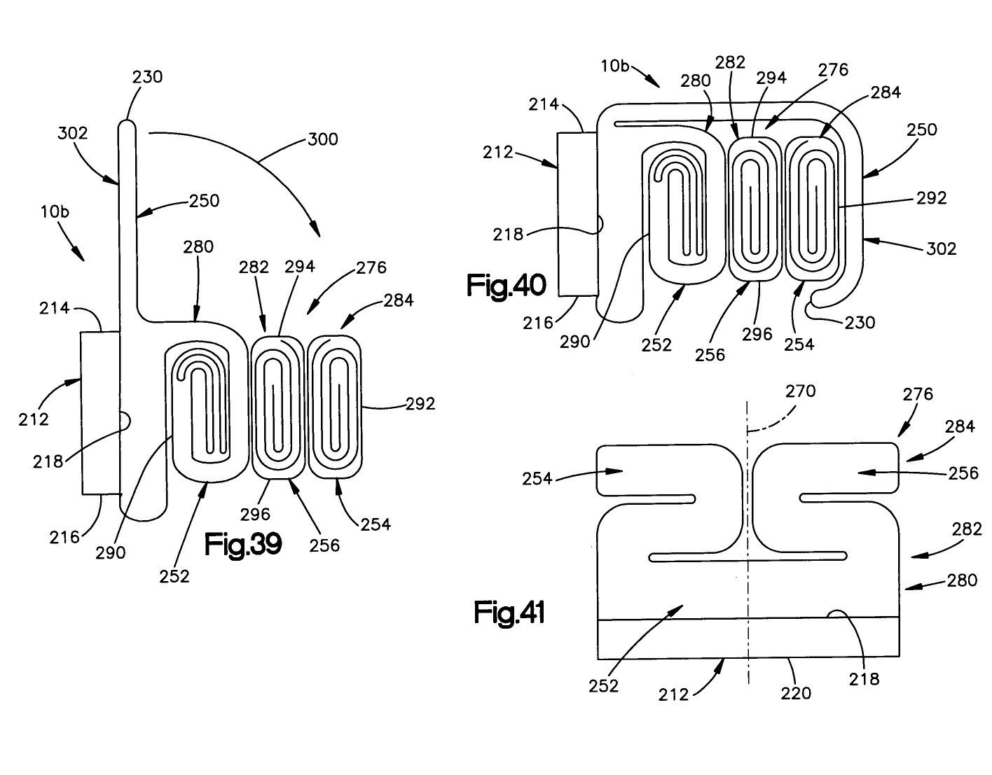

When the first and second side portions 254 and 256 of the air bag 10b are folded into the positions shown in FIG. 38, the parts of the first and second side portions 254 and 256 that were rolled during the rolling of the bottom portion 252 of the air bag are disposed in a stack 276 with the bottom portion. FIGS. 38 and 39 illustrate the stack 276. The stack 276 includes first, second, and third layers 280, 282, and 284, respectively. The bottom portion 252 of the air bag 10b forms the first layer 280 of the stack 276. The part of the second side portion 256 that was rolled with the bottom portion 252 of the air bag 10b forms the second layer 282 of the stack 276. The part of the first side portion 254 that was rolled with the bottom portion 252 of the air bag 10b forms the third layer 284 of the stack 276.

As shown in FIG. 39, the stack 276 includes opposites first and second side surfaces 290 and 292, respectively, and upper and lower surfaces 294 and 296, respectively. The first layer 280, i.e., the bottom portion 252 of the air bag 10b, forms the first side surface 290 of the stack 276. The first side surface 290 of the stack 276 is positioned adjacent the front face 218 of the retainer 212, as is shown in FIG. 39. The third layer 284, i.e., the first side portion of the air bag 10b, forms the second side surface 292 of the stack 276. The upper and lower surfaces 294 and 296 of the stack 276 include portions of each of the first, second, and third layers 280, 282, and 284.

After the first and second side portions 254 and 256 are folded laterally inwardly to form the stack 276, the top portion 250 of the air bag 10b is moved downwardly, in the direction of arrow 300 in FIG. 39. The top portion 250 of the air bag 10b forms a flap 302 that extends over the upper surface 294 of the stack 276 and over the second side surface 292 of the stack. FIG. 40 illustrates the air bag 10b in the second configuration. When in the second configuration, the top edge 230 of the flap 302, i.e., the top portion 250 of the air bag 10b, terminates adjacent the lower surface 296 of the stack 276.

When the air bag 10b is mounted in the instrument panel 14 (FIG. 1) of the vehicle 16, the top portion 250 of the air bag 10b and the top edge 214 of the retainer 212 are located nearest the windshield 20 (FIG. 1). Thus, in the top mounted configuration illustrated in FIG. 1, the top portion 250 of the air bag 10b is the forwardmost portion of the air bag and is not necessarily the vertically highest portion of the air bag.

During inflation of the air bag 10b, the flap 302 formed by the top portion 250 is the first portion of the air bag 10b to receive inflation fluid. When inflation fluid is received in the flap 302, the top portion 250 of the air bag 10b inflates toward the windshield 20 (FIG. 1) of the vehicle 16. After the top portion 250 of the air bag 10b is inflated, the first and second side portions 254 and 256 of the air bag 10b are inflated. The first and second side portions 254 and 256 move laterally outwardly and away from the retainer 212 in response to receiving inflation fluid. This lateral inflation of the first and second side portions 254 and 256 occurs prior to any substantial unrolling of the bottom portion 252 of the air bag 10b. Since the first side portion 254 overlies the second side portion 256, as shown in FIG. 38, the first side portion 254 inflates slightly earlier than the second side portion 256. After the first and second side portions 254 and 256 are inflated, the bottom portion 252 of the air bag 10b inflates downwardly.

FIG. 41 illustrates schematically a folding step that may be substituted for the folding step shown in FIG. 38. In the folding step shown in FIG. 41, the first and second side portions 254 and 256 of the air bag 10b are folded laterally inwardly in a Z-fold configuration similar to that described with reference to FIG. 16. In the Z-fold configuration, the first and second side portions 254 and 256 are folded as mirror images of one another. The first side portion 254 of the air bag 10b is located completely on the left side of the centerline 270, as viewed in FIG. 41, and the second side portion 256 of the air bag is located completely on the right side of the centerline, as viewed in FIG. 41. As a result, the first side portion 254 forms one half of the second layer 282 of the stack 276 and one half of the third layer 284 of the stack. Similarly, the second side portion 256 forms one half of the second layer 282 of the stack 276 and one half of the third layer 284 of the stack. When an air bag 10b folded in a manner that includes the step illustrated in FIG. 41 is inflated, the first and second side portions 254 and 256 of the air bag 10b inflate simultaneously.

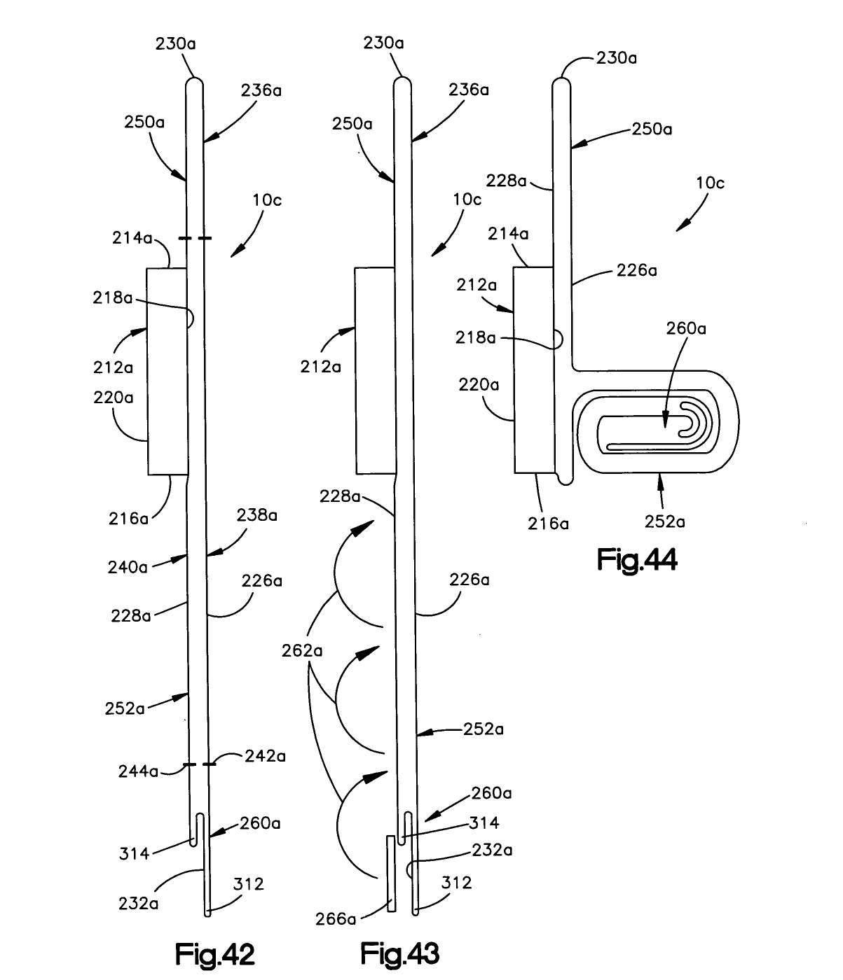

FIGS. 42-47 illustrate schematically a process of folding an air bag 10c in accordance with a fourth embodiment of the invention. The folding process shown in FIGS. 42-47 is similar to the folding process shown in FIG. 32-40. In FIGS. 42-47, portions of the air bag 10c and the retainer 212a that are similar to those portions shown and described with reference to FIGS. 32-40 are numbered with the same reference number as in FIGS. 32-40 with the addition of the suffix “a”.

The folding process illustrated in FIGS. 42-47 begins with the air bag 10c positioned in the same configuration as shown with regard to the air bag 10b of FIG. 32. The configuration illustrated in FIG. 32 also represents a first configuration for the folding process of the air bag 10c of FIGS. 42-47. After the air bag 10c is placed in the first configuration, the air bag 10c is manipulated, in a series of steps, from the first configuration to a second configuration. FIG. 47 illustrates the air bag 10c in the second configuration. In the second configuration, the air bag 10c is in a condition for storage in the instrument panel 14 (FIG. 1) of the vehicle 16.

To start the process of manipulating the air bag 10c from the first configuration to the second configuration, the bottom edge 232a of the air bag 10c is tucked into the air bag to form a pleat 260a, as shown in FIG. 42. The pleat 260a that is formed includes front and back portions 312 and 314, respectively. The front and back portions 312 and 314 of the pleat 260a have different lengths with the front portion of the pleat being approximately three times longer than the back portion.

After the pleat 260a is formed, the bottom portion 252a of the air bag 10c is flat rolled three to four times in a bottom to top direction along the back part 228a of the air bag, as shown by the arrows 262a in FIG. 43. The rolling of the bottom portion 252a of the air bag 10c may be performed with the aid of a paddle 266a. The bottom portion 252a is rolled into the configuration shown in FIG. 44. When the bottom portion 252a is configured as shown in FIG. 44, the paddle 266a, if used, should be removed.

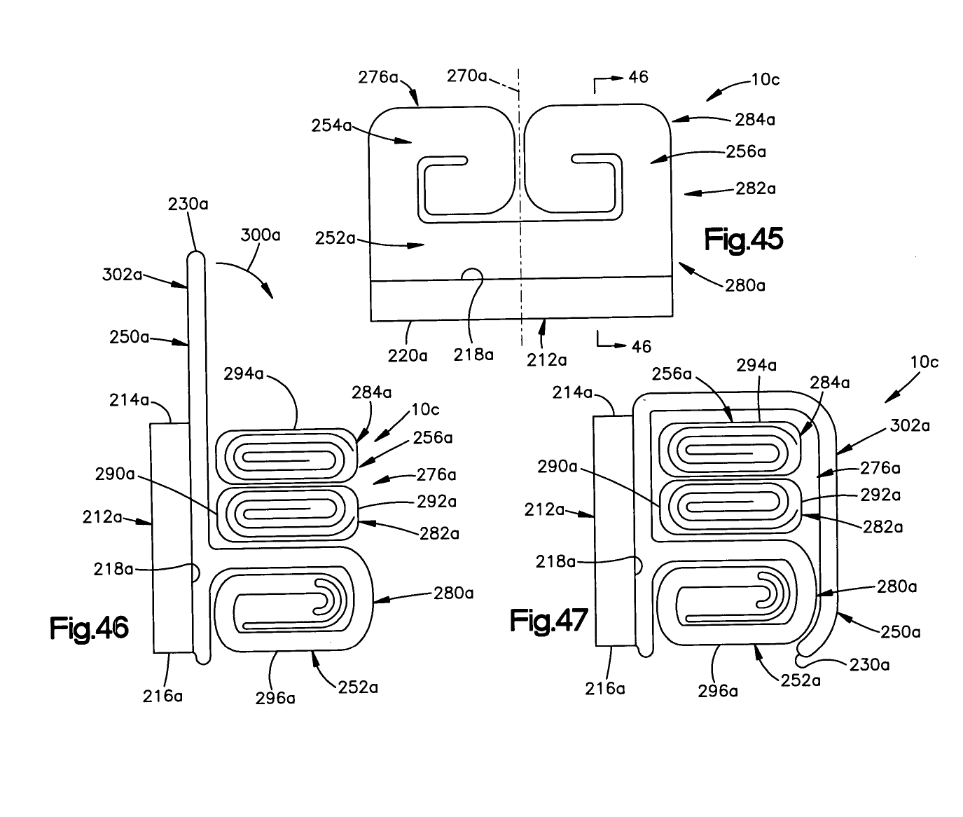

At this point in the process, the first and second side portions 254a and 256a of the air bag 10c are still located laterally outward of the retainer 212a, in positions similar to those illustrated in FIG. 37 with reference to the air bag 10b. Next, the first and second side portions 254a and 256a of the air bag 10c are folded laterally inwardly into the positions shown in FIG. 45. To fold the first side portion 254a into the position shown in FIG. 45, the first side portion 254a of the air bag 10c is flip folded onto itself two times. In the illustrated configuration, the first side portion 254a of the air bag 10c is located to the left of the centerline 270a, as viewed in FIG. 45. Similarly, to fold the second side portion 256a into the position shown in FIG. 45, the second side portion 256a of the air bag 10c is flip folded onto itself two times. In the illustrated configuration, the second side portion 256a of the air bag 10c is located to the right of the centerline 270a, as viewed in FIG. 45. As shown in FIG. 45, the folded first and second side portions 254a and 256a are mirror images of one another.

When the first and second side portions 254a and 256a of the air bag 10c are folded into the positions shown in FIG. 45, the parts of the first and second side portions 254a and 256a that were rolled with the bottom portion 252a of the air bag 10c are disposed in a stack 276a with the bottom portion 252a. As shown in FIGS. 45 and 46, the stack 276a includes first, second, and third layers 280a, 282a, and 284a. The bottom portion 252a of the air bag 10c forms the first layer 280a of the stack 276a. As shown in FIG. 45, the part of the first side portion 254a that is rolled with the bottom portion 252a of the air bag 10c forms one half of the second layer 282a and one half of the third layer 284a. Likewise, the part of the second side portion 256a that is rolled with the bottom portion 252a of the air bag 10c forms one half of the second layer 282a and one half of the third layer 284a.

As shown in FIG. 46, the stack 276a includes opposites first and second side surfaces 290a and 292a, respectively, and upper and lower surfaces 294a and 296a, respectively. Portions of each of the first, second, and third layers 280a, 282a, and 284a form the first and second side surfaces 290a and 292a of the stack 276a. The first layer 280a, i.e., the bottom portion 252a of the air bag 10c, forms the lower surface 296a of the stack 276a. Portions of the first and second side portions 254a and 256a form the upper surface 294a of the stack 276a. In FIG. 46, the first side surface 290a of the stack 276a is positioned adjacent the front face 218a of the retainer 212a.

After the first and second side portions 254a and 256a are folded laterally inwardly, the top portion 250a of the air bag 10c is folded downwardly, in the direction of arrow 300a in FIG. 46. The top portion 250a of the air bag 10c forms a flap 302a that extends over the upper surface 294a of the stack 276a and over the second side surface 292a of the stack. FIG. 47 illustrates the air bag 10c in the second configuration. When in the second configuration, the top edge 230a of the top portion 250 of the air bag 10c terminates adjacent the bottom surface 296a of the stack 276a.

When the air bag 10c is mounted in the instrument panel 14 (FIG. 1) of the vehicle 16, the top portion 250a of the air bag 10c and the top edge 214a of the retainer 212a are located nearest the windshield 20 (FIG. 1). Thus, in the top mounted configuration illustrated in FIG. 1, the top portion 250a of the air bag 10c is the forwardmost portion of the air bag and is not necessarily the vertically highest portion of the air bag.

When the air bag 10c is inflated, the flap 302 formed by the top portion 250a of the air bag 10c is the first portion of the air bag to receive inflation fluid. When inflation fluid is received in the flap 302a, the top portion 250a of the air bag 10c inflates toward the windshield 20 (FIG. 1) of the vehicle 16. After the top portion 250a of the air bag 10c is inflated, the first and second side portions 254a and 256a are inflated. The first and second side portions 254a and 256a move laterally outwardly and away from the retainer 212a in response to receiving inflation fluid. This lateral inflation of the first and second side portions 254a and 256a occurs prior to any substantial unrolling of the bottom portion 252a of the air bag 10c. The first and second side portions 254a and 256a of the air bag 10c inflate simultaneously. After the first and second side portions 254a and 256a are inflated, the bottom portion 252a of the air bag 10c inflates downwardly.

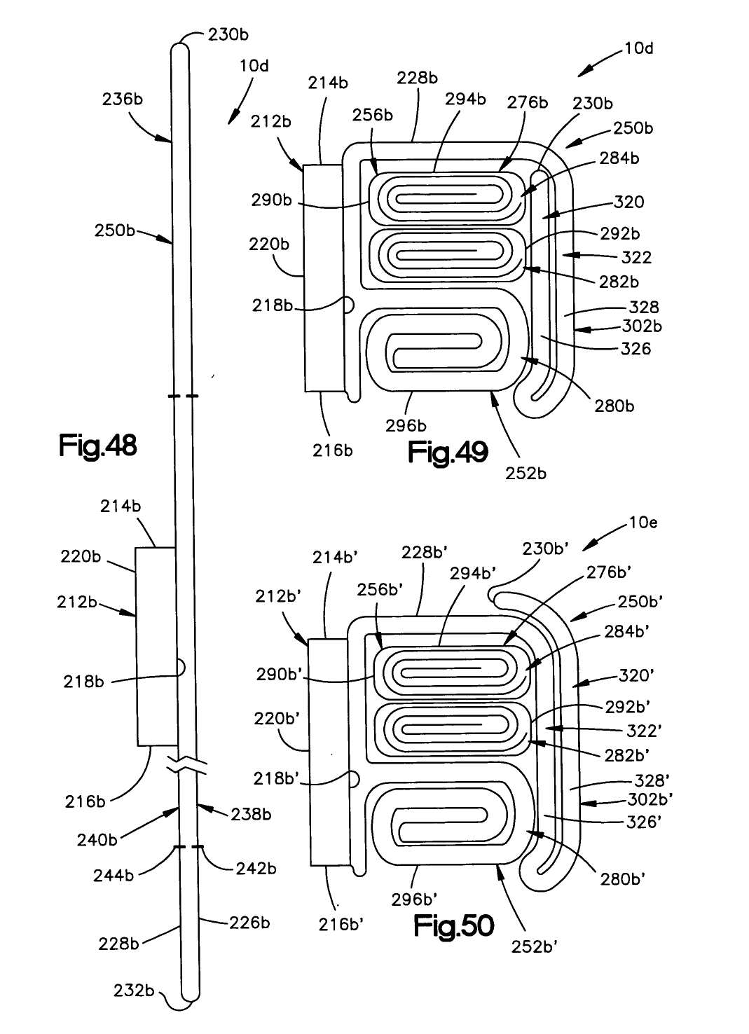

FIG. 48 illustrates an alternative air bag 10d that may be packed into a stored condition in accordance with the present invention. The air bag 10d of FIG. 48 is similar to the air bag 10b of FIG. 32 with the exception that the top portion 250b of the air bag of FIG. 48 is significantly longer than the top portion 250 of the air bag 10b of FIG. 32. For example, the top portion 250b of the air bag 10d of FIG. 48 is preferably about 310 millimeters long, whereas, the top portion 250 of the air bag 10b of FIG. 32 is preferably about 130 millimeters long. Since the air bag 10d of FIG. 48 is similar to the air bag 10b of FIG. 32, structures of the air bag 10d of FIG. 48 that are the same as or similar to structures of the air bag 10b of FIG. 32 are referenced with the same reference number as in FIG. 32 with the addition of the suffix “b”.

FIG. 49 illustrates a second configuration of the air bag 10d of FIG. 48 folded in accordance with a fifth embodiment of the present invention. No pleat is formed in the bottom portion 252b of the air bag 10d of FIG. 49. The bottom portion 252b of the air bag 10d is rolled and is formed into a stack 276b with parts of the first and second side portions 254b and 256b of the air bag 10d, in a manner similar to that disclosed and illustrated with reference to FIGS. 43-46.

The top portion 250b of the air bag 10d forms a flap 302b. The flap 302b includes an end portion 320 that is flip folded forward over a front part 226b of the air bag 10d so as to overlap an intermediate portion 322 of the flap. The flap 302b is then moved into a position extending over the upper surface 294b of the stack 276b, over the second side surface 292b of the stack, and into the second configuration illustrated in FIG. 49. When in the second configuration, the flap 302b includes inner and outer layers 326 and 328, respectively. Both the inner and outer layers 326 and 328 extend over the second side surface 292b of the stack 276b. When in the second configuration, the end portion 320 of the flap 302b forms the inner layer 326 and is interposed between the second side surface 292b of the stack 276b and the outer layer 328. The intermediate portion 322 of the flap 302b forms the outer layer 328.

The air bag 10d of FIG. 49 inflates in substantially the same manner as the air bag 10c of FIG. 47. When the flap 302b of the air bag 10d of FIG. 49 receives inflation fluid, the flap 302b begins to inflate toward the windshield 20 (FIG. 1) of the vehicle 16 with the end portion 320 of the flap remaining folded over the intermediate portion 322. The end portion 320 of the flap 302b is the last portion of the top portion 250b of the air bag 10d to inflate.

FIG. 50 illustrates a second configuration of an air bag 10e folded in accordance with a sixth embodiment of the present invention. The air bag 10e of FIG. 50 is similar to the air bag 10d of FIGS. 48 and 49. Therefore, structures of the air bag 10e of FIG. 50 that are the same as or similar to structures of the air bag 10d of FIGS. 48-49 are numbered with the same reference numbers with the addition of a prime.

No pleat is formed in the bottom portion 252b′ of the air bag 10e. The bottom portion 252b′ of the air bag 10e is rolled and is formed into a stack 276b′ with parts of the first and second side portions 254b′ and 256b′ of the air bag 10e, in a manner similar to that disclosed and illustrated with reference to FIGS. 43-46.

The top portion 250b′ of the air bag 10e forms a flap 302b′. The flap 302b′ includes an end portion 320′ that is flip folded backward over a back part 228b′ of the air bag 10e so as to overlap an intermediate portion 322′ of the flap. The flap 302b′ is then moved into a position extending over the upper surface 294b′ of the stack 276b′, over the second side surface 292b′ of the stack, and into the second configuration illustrated in FIG. 50. When in the second configuration, the flap 302b′ forms inner and outer layers 326′ and 328′. Both the inner and outer layers 326′ and 328′ extend over the second side surface 292b′ of the stack 276b′. When in the second configuration, the end portion 320′ of the flap 302b′ forms the outer layer 328′, which overlies the inner layer 326′ and the second side surface 292b′ of the stack 276b′. The intermediate portion 322′ of the flap 302b′ forms the inner layer 326′. The air bag 10e of FIG. 50 inflates in substantially the same manner as the air bag 10d of FIG. 49.

From the above description of the invention, those skilled in the art will perceive improvements, changes and modifications in the invention. For example, not all air bags are symmetrical side to side. As a result, the longer side might be folded either with bigger folds or with more folds than the shorter side. Thus, the side to side folding of an bag in accordance with the present invention need not be done with the sides being folded as mirror images of each other. In addition, some air bags do not have retainers, but instead are secured directly to the inflator or to the housing. Thus, the folding of an air bag in accordance with the present invention need not be to a condition overlying a retainer; the retainer is used herein only as illustrating the dimensions and location of the final folded condition of the air bag. Such improvements, changes and modifications within the skill of the art are intended to be covered by the appended claims.

Having described the invention, we claim the following:

1. A method of disposing an inflatable vehicle occupant protection device in a stored condition adjacent a retainer to which the inflatable vehicle occupant protection device is connected, the inflatable vehicle occupant protection device including a bottom portion, a top portion, and first and second side portions, the method comprising the steps of:
packing the bottom portion of the inflatable vehicle occupant protection device;
disposing parts of the first and second side portions that are packed with the bottom portion in a stack with the bottom portion so that the stack includes three layers, one of which is formed by the bottom portion and two of which are formed by the first and second side portions;
positioning a first side surface of the stack adjacent the retainer;
forming a flap from the top portion of the inflatable vehicle occupant protection device; and
extending the flap from the retainer and over a second side surface of the stack, the second side surface of the stack being located opposite the first side surface of the stack.

2. The method of claim 1 wherein the step of packing the bottom portion of the inflatable vehicle occupant protection device includes the step of rolling the bottom portion of the vehicle occupant protection device.

3. The method of claim 1 wherein the step of extending the flap from the retainer and over a second side surface of the stack also includes the step of extending the flap over an upper surface of the stack.

4. The method of claim 1 wherein the step of disposing parts of the first and second side portions that are packed with the bottom portion in a stack with the bottom portion further includes the steps of forming a first layer with the bottom portion of the vehicle occupant protection device, forming second and third layers with the first and second side portions, and disposing the second and third layers adjacent to the first layer.

5. The method of claim 4 wherein step of forming second and third layers with the first and second side portions includes the step folding the first and second side portions upon themselves so that the first side portion forms a first portion of each of the second and third layers of the stack and the second side portion forms a second portion of each of the second and third layers of the stack.

6. The method of claim 5 further including the step of folding the first and second side portions into Z-shaped configurations.

7. The method of claim 1 wherein the step of extending the flap from the retainer and over a second side surface of the stack further includes the steps of extending the flap across a top surface of the stack and terminating an end portion of the flap adjacent a bottom surface of the stack.

8. The method of claim 1 wherein the step of extending the flap from the retainer and over a second side surface of the stack further includes the steps of folding the top portion of the vehicle occupant protection device upon itself to form inner and outer layers and extending each of the inner and outer layers over the second side surface of the stack.

9. The method of claim 8 further including the steps of forming the inner layer with an end portion of the flap and positioning the inner layer between the stack and the outer layer.

10. The method of claim 8 wherein further including the steps of forming the outer layer with an end portion of the flap and positioning the outer layer over the inner layer.

11. An apparatus comprising:
a retainer; and
an inflatable vehicle occupant protection device that is connected to the retainer, the inflatable vehicle occupant protection device including a bottom portion, a top portion, and first and second side portions,
the inflatable vehicle occupant protection device having a stored condition in which the bottom portion is packed, parts of the first and second side portions that are packed with the bottom portion are disposed in a stack with the bottom portion, the stack including three layers, one of which is formed by the bottom portion and two of which are formed by the first and second side portions, the stack including opposite first and second side surfaces, a first side surface of the stack being positioned adjacent the retainer,
the top portion of the inflatable vehicle occupant protection device forming a flap, the flap extending from the retainer and over the second side surface of the stack.

12. The apparatus of claim 11 wherein the bottom portion of the vehicle occupant protection device is rolled.

13. The apparatus of claim 11 wherein the flap formed by the top portion of the vehicle occupant protection device also extends over an upper surface of the stack.

14. The apparatus of claim 11 wherein the three layers of the stack include first, second, and third layers with the second and third layers being disposed adjacent to the first layer.

15. The apparatus of claim 14 wherein the bottom portion of the vehicle occupant protection device forms the first layer and the first and second side portions form the second and third layers.

16. The apparatus of claim 11 wherein the bottom portion of the vehicle occupant protection device forms the first side surface of the stack and the second side surface of the stack is formed by at least one of the first and second side portions.

17. The apparatus of claim 16 wherein the flap extends across a top surface of the stack and an end portion of the flap terminates adjacent a bottom surface of the stack.

18. The apparatus of claim 11 wherein the first and second side portions are folded upon themselves so that the first side portion forms a first portion of two layers of the stack and the second side portion forms a second portion of two layers of the stack.

19. The apparatus of claim 18 wherein the first and second side portions are folded into Z-shaped configurations.

20. The apparatus of claim 11 wherein the three layers of the stack collectively form both the first and second side surfaces of the stack.

21. The apparatus of claim 11 wherein the flap formed by the top portion of the vehicle occupant protection device is folded upon itself to form inner and outer layers, each of the inner and outer layers extending over the second side surface of the stack.

22. The apparatus of claim 21 wherein an end portion of the flap forms the inner layer and is interposed between the stack and the outer layer.

23. The apparatus of claim 21 wherein an end portion of the flap forms the outer layer.
